(19) United States
(12) Patent Application Publication
(10) Pub. No.: US 2007/0052311 A1
(43) Pub. Date: Mar. 8, 2007

(54) Motor having dynamic pressure bearing and disc drive having the motor

(75) Inventors: Hiroshi Nagata, Kawasaki (JP); Mitsuaki Yoshida, Kawasaki (JP); Yoshiaki Koizumi, Kawasaki (JP); Ritsuko Minamisawa, Kawasaki (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: FUJITSU LIMITED, Kawasaki (JP)

(21) Appl. No.: 11/318,542

(22) Filed: Dec. 28, 2005

(30) Foreign Application Priority Data
Sep. 8, 2005 (JP) 2005-260265

(51) Int. Cl. H02K 5/16; G11B 17/04

(52) U.S. Cl. 310/90; 384/107; 384/112; 360/99.07

(57) ABSTRACT

A motor includes a shaft that rotates with a load, and a dynamic pressure bearing that supports the shaft via fluid in a non-contact manner, wherein the dynamic pressure bearing includes three or more radial bearings that are arranged along a longitudinal direction of said shaft and each radial bearing extends around said shaft.

This application claims the right of a foreign priority based on Japanese Patent Application No. 2005-260265, filed on Sep. 8, 2005, which is hereby incorporated by reference herein in its entirety as if fully set forth herein.

### BACKGROUND OF THE INVENTION

The present invention relates generally to a motor having a dynamic pressure bearing and a disc drive having the motor, and more particularly to a structure of a radial bearing of the dynamic pressure bearing. The present invention is suitable, for example, for a spindle motor that is used for a hard disc drive (“HDD”) and rotates a disc.

Along with the recent spread of the Internet etc., there increase demands for quickly recording a large amount of information. A magnetic disc drive, such as a HDD, thus has increasingly been required to have an increased large capacity and a high response. For the large capacity, the HDD narrows a track pitch of the disc, and increases the number of discs to be housed. For the improved response, the HDD increases the rotational speed of the spindle motor.

A high recording density disc needs a high head positioning precision, and thus should improve a rotating precision while restraining disc vibrations. Therefore, a spindle motor has adopted a dynamic pressure bearing that supports a shaft in a non-contact manner. As a result, the spindle motor can prevent disc vibrations due to the contact between the bearing and the shaft, which is seen in a conventional ball bearing. In the dynamic pressure bearing, the fluid, such as lubricant oil, filled in an aperture between the shaft and the bearing generates a (fluid) pressure due to the wedge effect, and this pressure supports a load. The dynamic pressure bearing is classified into a radial bearing and a thrust bearing by load direction. Two radial bearings are arranged along the longitudinal direction of the shaft and each radial bearing extends around the shaft. The fluid pressure enhances the rigidity of the shaft, and effectively prevents the oscillation of the shaft. Prior art include, for example, Japanese Patent Application, Publication No. 2001-214929.

However, as the number of rotations of the spindle motor and the number of installed discs increase, the shaft vibrations increase, while the rotating precision of the disc becomes stricter due to the high recording density. Therefore, the conventional radial bearing has a difficulty in maintaining the rotating accuracy of the disc. A conceivable solution for this problem is to enlarge the bearing or to narrow the aperture between the shaft and the bearing. Nevertheless, due to the fixed size of the motor, it is difficult to enlarge the bearing. In addition, it is difficult to narrow the aperture due to the processing accuracy and the assembly easiness.

### BRIEF SUMMARY OF THE INVENTION

Accordingly, it is an exemplary object of the present invention to provide a motor having a radial bearing as a dynamic pressure bearing that improves the rotating precision, and a disc drive having the motor.

A motor according to one aspect of the present invention includes a shaft that rotates with a load, and a dynamic pressure bearing that supports said shaft via fluid in a non-contact manner, wherein said dynamic pressure bearing includes three or more radial bearings that are arranged along a longitudinal direction of said shaft and each radial bearing extends around said shaft. This motor has more radial bearings than the conventional one, and maintains the rotating precision by enhancing the rigidity of the shaft. The motor can easily reduce the moment applied to the shaft by adjusting the number of bearings and their locations while maintaining the aperture between the shaft and the size of each bearing. Preferably, a center of the three or more radial bearings along the longitudinal direction of said shaft accords with a center of the load along the longitudinal direction of said shaft. The accordance between a center or a center of gravity of the radial bearing and that of the load reduces the moment applied to the shaft, and improve the rotating precision. As long as both centers accord with each other in a range in which the moment is substantially negligible, a slight discordance is within the scope of the present invention.

A disc drive that includes the above motor as the spindle motor also constitutes one aspect of the present invention.

Other objects and further features of the present invention will become readily apparent from the following description of the preferred embodiments with reference to accompanying drawings.

### BRIEF DESCRIPTION OF THE DRAWINGS

FIG. 1 is a plane view of an internal structure of a hard disc drive (“HDD”) according to one embodiment of the present invention.

FIG. 2 is an enlarged perspective view of a magnetic head part in the HDD shown in FIG. 1.

FIG. 3 is a longitudinal sectional view of a spindle motor in the HDD shown in FIG. 1.

FIGS. 4A to 4C are sectional views showing changes of a center position of the spindle motor along its longitudinal direction when the number of discs shown in FIG. 1 changes to 1, 2, and 4.

FIG. 5 is a block diagram of a control system in the HDD shown in FIG. 1.

### DETAILED DESCRIPTION OF THE PREFERRED EMBODIMENTS

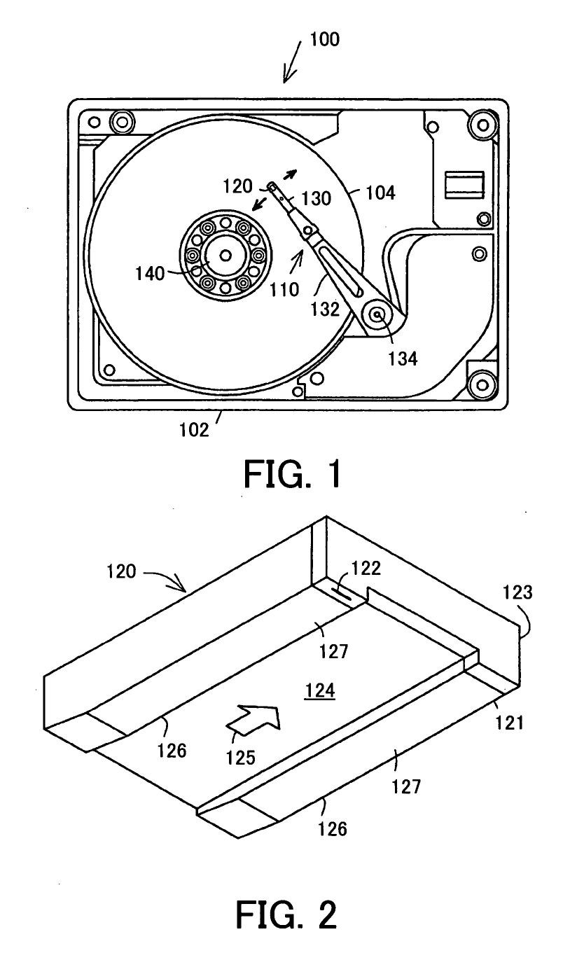

Referring now to the accompanying drawings, a description will be given of a HDD 100 according to one embodiment of the present invention. The HDD 100 includes, as shown in FIG. 1, one or more magnetic discs 104 each serving as a recording medium, a spindle motor 106, and a head stack assembly (“HSA”) 110 in a housing 102. Here, FIG. 1 is a schematic plane view of the internal structure of the HDD 100.

The housing 102 is made, for example, of aluminum die cast base and stainless steel, and has a rectangular parallelepiped shape to which a cover (not shown) that seals the internal space is joined. The magnetic disc 104 of this embodiment has a high surface recording density, such as 200 Gb/in² or greater. The magnetic disc 104 is mounted on a spindle of the spindle motor 106 through its center hole of the magnetic disc 104.

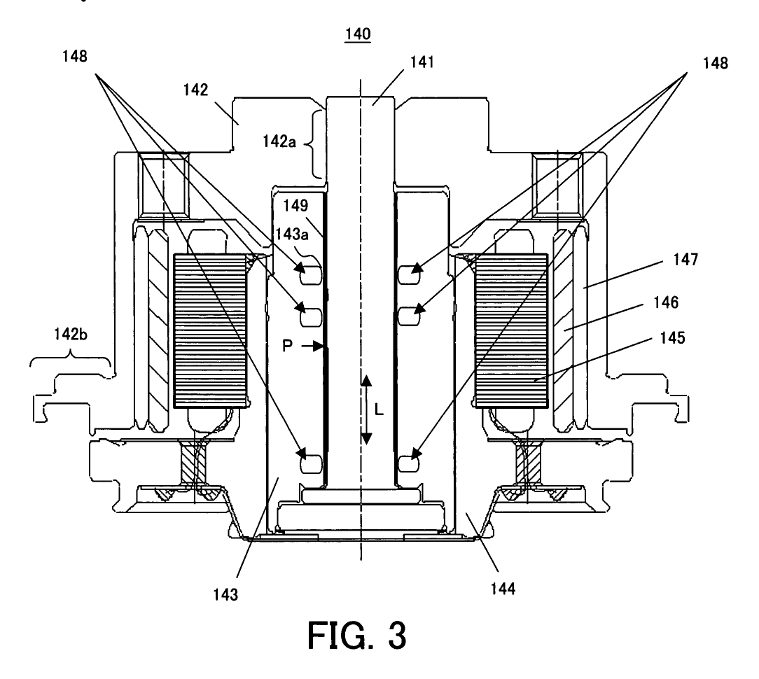

The spindle motor 106 rotates the magnetic disc 104 at such a high speed as 10,000 rpm. The spindle motor 140 includes, as shown in FIG. 3, a shaft 141, a hub 142, a sleeve 143, a bracket 144, a core 145, and a magnet 146, a yoke 147, radial bearings 148, and lubricant oil (fluid) 149. Here, FIG. 3 is a longitudinal sectional view of the spindle motor 140.

The shaft 141 rotates with the disc 104 that serves as a load. The hub 142 is fixed onto the shaft 141 at its top 142a, and supports the disc 104 on its support surface 142b. The sleeve 143 is a member that allows the shaft 141 to be mounted rotatably. The sleeve 143 is fixed in the housing 102. While the shaft 141 rotates, the sleeve 143 does not rotate and forms a fixture part with a bracket 144. The sleeve 143 has a groove or aperture 143a into which the lubricant oil 149 is introduced. As the shaft 141 rotates, the lubricant oil 149 generates the dynamic pressure (fluid pressure) along the groove 143a. The bracket 144 is fixed onto the housing 102 around the sleeve 143, and supports the core (coil) 145, the magnet 146, and the yoke 147. The current flows through the core 145, and the core 145, the magnet 146 and the yoke 147 constitute a magnetic circuit. The magnetic circuit faces a voice coil motor of a carriage, and is used to swing a head.

The radial bearing 148 is a dynamic pressure bearing that supports the shaft 141 in a non-contact manner via the lubricant oil 149. There are three or more (although three in this embodiment) along the longitudinal direction of the shaft 141, and each radial bearing 148 extends around the shaft 141. The radial bearing 148 supports the load in the radial direction of the shaft 141. Thus, the number (i.e., three) of radial bearings 148 of this embodiment is more than the number (i.e., two) of conventional radial bearings. Therefore, this embodiment can enhance the rigidity of the shaft 141, and maintain the rotating precision. In addition, this embodiment easily reduces the moment applied to the shaft 141 by adjusting the number of the bearings 148 and their locations while maintaining the aperture 143a between the shaft 141 and the bearing 148 and the size of each bearing 148.

A center P of the radial bearings 148 along the longitudinal direction L of the shaft 141 preferably accords with a center of the discs 104 along the longitudinal direction L of the shaft 141. The accordance between a center or a center of gravity of the radial bearings 148 and that of the discs 104 reduces the moment applied to the shaft 141, and improve the rotating precision.

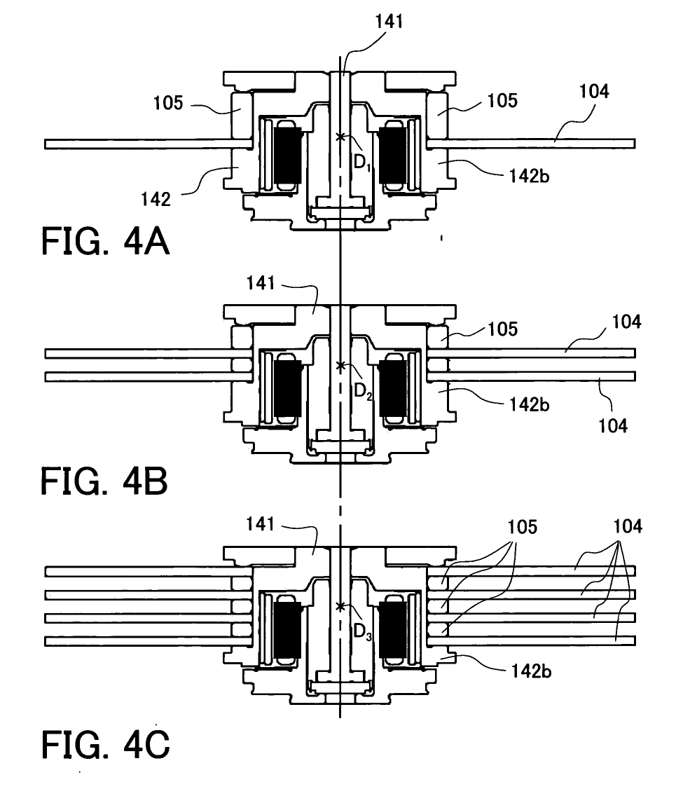

FIGS. 4A to 4C are sectional views showing changes of the center position on along the shaft 141 when the number of discs varies among 1, 2 and 4. 105 in FIGS. 4A to 4C denotes a clamp that fixes the disc 104. A center D₂ shown in FIG. 4B is located above a center D₁ shown in FIG. 4A, and a center D₃ shown in FIG. 4C is located above the center D₂ shown in FIG. 4B. When the center P of the radial bearings 148 is accorded with the centers D₁ to D₃ by adjusting the number of radial bearings 148 and their locations, the moment applied to the shaft 141 can be reduced. Here, the centers P, D₁ to D₃ can be easily obtained by setting the longitudinal direction L of the shaft 141 horizontal to the ground and arranging the equivalent loads at positions of the radial bearings 148 and the discs 104.

As long as both centers accord with each other in a range in which the moment is substantially negligible, a slight discordance is within the scope of the present invention. The negligible range is, but not limited to, within ±10% in this embodiment.

The HSA 110 includes a magnetic head part 120, a suspension 130, a carriage 132, and a support shaft 134.

The magnetic head 120 includes, as shown in FIG. 2, an approximately square, Al₂O₃— TiC (Altic) slider 121, and a head device built-in film 123 that is joined with an air outflow end of the slider 121 and has a reading and recording head 122. Here, FIG. 2 is an enlarged view of the magnetic head part 120. The slider 121 and the head device built-in film 123 define a medium opposing surface to the magnetic disc 104, i.e., a floating surface 124. The floating surface 124 receives an airflow 125 that occurs as the magnetic disc 104 rotates.

A pair of rails 126 extend on the floating surface 124 from the air inflow end to the air outflow end. A top surface of each rail 126 defines a so-called air-bearing surface (“ABS”) 127. The ABS 127 generates the buoyancy due to actions of the airflow 125. The head 122 embedded into the head device built-in film 123 exposes from the ABS 127. The floating system of the magnetic head part 120 is not limited to this mode, and may use known dynamic and static pressure lubricating systems, piezoelectric control system, and other floating systems. The activation system may be a contact start stop (“CSS”) system in which the magnetic head part 120 contacts the disc 104 at the stop time, or a dynamic or ramp loading system in which the magnetic head part 120 is lifted up from the disc 104 at the stop time and held on the ramp outside the disc 104 while the magnetic head part 120 does not contact the disc 104, and the magnetic head part 120 is dropped from the holding part to the disc 104 at the start time.

The head 122 is a MR inductive composite head that includes an inductive head device that writes binary information in the magnetic disc 104 utilizing the magnetic field generated by a conductive coil pattern (not shown), and a magnetoresistive (“MR”) head that reads the binary information based on the resistance that varies in accordance with the magnetic field applied by the magnetic disc 104. A type of the MR head device is not limited, and may use a giant magnetoresistive (“GMR”), a CIP-GMR (“GMR”) that utilizes a current in plane (“CIP”), a CPP-GMR that utilizes a perpendicular to plane (“CPP”), a tunneling magnetoresistive (“TMR”), an anisotropic magnetoresistive (“AMR”), etc.

The suspension 130 serves to support the magnetic head part 120 and to apply an elastic force to the magnetic head part 120 against the magnetic disc 104, and is, for example, a Watlas type suspension made of stainless steel. This type of suspension has a flexure (also referred to as a gimbal spring or another name) which cantilevers the magnetic head part 120, and a load beam (also referred to as a load arm or another name) which is connected to the base plate. The suspension 130 also supports a wiring part 138 that is connected to the magnetic head part 120 via a lead etc. Via this lead, the sense current flows and read/write information is transmitted between the head 122 and the wiring part 138.

The carriage 132 is swung around the support shaft 134 by a voice coil motor (not shown). A support part of the carriage 132 is referred to as an arm, which is an aluminum rigid member that can rotate or swing around the support shaft 134. The carriage 132 includes a flexible printed board (“FPC”) that provides the wiring part 138 with a control signal, a signal to be recorded in the disc 104, and the power, and receives a signal reproduced from the disc 104.

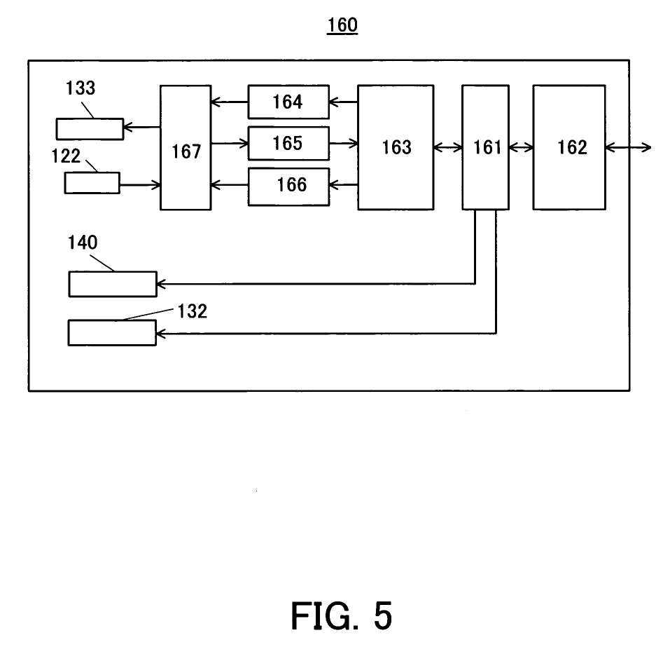

FIG. 5 shows a control block diagram of a control system 160 in the HDD 100. The control system 160 is a control illustration in which the head 122 has the inductive head and the MR head. The control system 160, which can be implemented as a control board in the HDD 100, includes a controller 161, an interface 162, a hard disc controller (referred to as “HDC” hereinafter) 163, a write modulator 164, a read demodulator 165, a sense-current controller 166, and a head IC 167. Of course, they are not necessarily integrated into one unit; for example, only the head IC 167 may be connected to the carriage 140.

The controller 161 covers any processor such as a CPU and MPU irrespective of its name, and controls each part in the control system 160. The interface 162 connects the HDD 100 to an external apparatus, such as a personal computer (“PC” hereinafter) as a host. The HDC 163 sends to the controller 161 data that has been demodulated by the read demodulator 165, sends data to the write modulator 164, and sends to the sense-current controller 166 a current value as set by the controller 161. Although FIG. 5 shows that the controller 161 provides servo control over the spindle motor 140 and (a motor in) the carriage 132, the HDC 163 may serve as such servo control.

The write modulator 164 modulates data and supplies data to the head IC 162, which data has been supplied, for example, from the host through the interface 162 and is to be written down onto the disc 104 by the inductive head. The read demodulator 165 demodulates data into an original signal by sampling data read from the disc 104 by the MR head device. The write modulator 164 and read demodulator 165 may be recognized as a single integrated signal processing part. The head IC 167 serves as a preamplifier. Each part may apply any structure known in the art, and a detailed description thereof will be omitted.

In operation of the HDD 100, the controller 161 drives the spindle motor 140 and rotates the discs 104. As discussed above, since the radial bearings 148 enhance the rigidity of the shaft 141 and reduce the moment applied to the shaft 141, the rotating precision of the disc 104 is maintained high. As a result, the highly precise head positioning accuracy can be provided. Since the HDD 100 rotates the discs 104 at a constant speed, the effect of the improved rotating accuracy is particularly enhanced. This is because the shaft vibrating characteristic varies as the disc rotating speed changes, and the arrangement of the radial bearings which has an effect of a vibration reduction of the shaft for a certain disc rotating speed is not always an effective vibration reduction of the shaft for another disc rotating speed.

The airflow associated with the rotation of the disc 104 is introduced between the disc 104 and slider 121, forming a minute air film and thus generating the buoyancy that enables the slider 121 to float over the disc surface. The suspension 130 applies an elastic compression force to the slider 121 in a direction opposing to the buoyancy of the slider 121. The balance between the buoyancy and the elastic force spaces the magnetic head part 120 from the disc 104 by a constant distance. The controller 161 then controls the carriage 132 and rotates the carriage 132 around the support shaft 134 for head 122's seek for a target track on the disc 104.

In writing, the controller 161 receives data from the host (not shown) such as a PC through the interface 162, selects the inductive head device, and sends data to the write modulator 164 through the HDC 163. In response, the write modulator 164 modulates the data, and sends the modulated data to the head IC 167. The head IC 167 amplifies the modulated data, and then supplies the data as write current to the inductive head device. Thereby, the inductive head device writes down the data onto the target track.

In reading, the controller 161 selects the MR head device, and sends the predetermined sense current to the sense-current controller 166 through the HDC 163. In response, the sense-current controller 166 supplies the sense current to the MR head device through the head IC 167. Thereby, the MR head reads desired information from the desired track on the disc 104.

Further, the present invention is not limited to these preferred embodiments, and various modifications and variations may be made without departing from the spirit and scope of the present invention.

What is claimed is:

1. A motor comprising:
a shaft that rotates with a load; and
a dynamic pressure bearing that supports said shaft via fluid in a non-contact manner, wherein said dynamic pressure bearing includes three or more radial bearings that are arranged along a longitudinal direction of said shaft and each radial bearing extends around said shaft.

2. A motor according to claim 1, wherein a center of the three or more radial bearings along the longitudinal direction of said shaft accords with a center of the load along the longitudinal direction of said shaft.

3. A disc drive comprising a motor according to claim 1.
